(19) United States
(12) Patent Application Publication
(10) Pub. No.: US 2008/0077767 A1
(43) Pub. Date: Mar. 27, 2008

(54) Method and apparatus for secure page swapping in virtual memory systems

(76) Inventors: Hormuzd M. Khosravi, Portland, OR (US); Uday Savagaonkar, Beaverton, OR (US); Ravi Sahita, Beaverton, OR (US); David Durham, Beaverton, OR (US); Travis Schluessler, Hillsboro, OR (US); Gayathri Nagabhushan, Portland, OR (US)

Correspondence Address: INTEL/BLAKELY, 1279 OAKMEAD PARKWAY, SUNNYVALE, CA, 94085-4040, US

(21) Appl. No.: 11/528,161

(22) Filed: Sep. 27, 2006

(51) Int. Cl. G06F 12/00; G06F 13/00

(52) U.S. Cl. 711/216; 711/159

(57) ABSTRACT

Embodiments described herein disclose a method and apparatus for secure page swapping in a virtual memory system. An integrity check value mechanism is used to protect software programs from run-time attacks against memory pages while those pages are swapped to secondary memory. A hash value is computed for an agent page as it is swapped from primary memory to secondary memory. When the page is swapped back into primary memory from secondary memory, that hash value is recomputed to verify that the page was not modified while stored in secondary memory. Alternatively, the hash value is pre-computed and placed in an integrity manifest wherein it is retrieved and verified when the page is loaded back into primary memory from secondary memory.

### BACKGROUND

Embodiments are in the field of computer systems, and more particularly in the field of platform management and security in virtual memory systems.

Virtual memory systems provide one or more logical address spaces that may be larger than the physical memory that is installed in a computer, thus effectively increasing the apparent amount of memory available to applications and processes running on the computer. In general, virtual memory allows non-contiguous memory to be presented to processes as contiguous memory, which comprises the virtual address space. Virtual memory addressing is typically used in paged memory systems in which memory pages stored in primary memory (e.g., system RAM (Random Access Memory)) are written to secondary storage (e.g., a hard disk) when not in use. This action has the effect of freeing up physical memory resources for use by more active processes. A page is the basic unit of memory used in a virtual memory system and typically ranges in size from 512 bytes to 8 Kbytes. A virtual memory manager maps logical addresses to physical addresses, which are usually stored in a page table.

Under normal circumstances, modification and processing of pages in a virtual memory system should occur only in primary memory, with the secondary memory used only for temporary storage so that the primary memory can be used to support other multi-tasked operations. A page that has been swapped from primary memory to secondary memory is marked as unavailable. When the CPU (Central Processing Unit) tries to access a page marked as unavailable, the memory management unit raises an exception (a page fault) with the CPU, which then jumps to a routine in the operating system. If the page is in the swap area, a page swap operation is invoked to load the page into primary memory. A page fault can also be generated if the data is in a memory-mapped file in the file system. Present operating systems typically handle unchanged code pages that are being removed from system memory by simply freeing the page, rather than writing it to the disk swap space. When the page needs to be accessed again, it will load the page from the file system.

To ensure data integrity, a page that has been swapped to secondary memory should not be modified in any way since it was last read from the primary memory. Due to the transfer of data between memory units, virtual memory systems can be vulnerable to corruption from computer bugs or attacks from so-called “malware,” such as viruses or worms, or other hacking activity. Protection for virtual memory systems is often incorporated into virtual memory management units. One limitation associated with many present virtual memory protection systems is that the agents protected by these systems must be privileged agents (i.e., ring 0 agents) and have their pages pinned in memory, that is, they cannot be swapped out to the secondary memory.

### BRIEF DESCRIPTION OF THE DRAWINGS

FIG. 1 is a block diagram of a computer system that implements embodiments of a secure page swapping mechanism for use in virtual memory systems.

FIG. 2 is a flow diagram that illustrates a method of performing a secure page swap, under an embodiment.

FIG. 3 is a flowchart that illustrates a method of performing a secure page swap when a user operating system changes its context, under an embodiment.

FIG. 4 is a flowchart that illustrates a method of performing a secure page swap for a page fault operation, under an embodiment.

FIG. 5 is a flow diagram that illustrates a method of processing instruction fetch and data access page faults, under an embodiment.

FIG. 6 is a flow diagram that illustrates a method of computing and checking hash values when a protected agent is trying to run, under an embodiment

FIG. 7 is a flow diagram that illustrates a method for a modified virtual TLB (translation lookaside buffer) operation in a secure page swap system, under an embodiment.

### DETAILED DESCRIPTION

Embodiments described herein disclose a method and apparatus for secure page swapping (paging to secondary memory) in a virtual memory system. An integrity check value mechanism is used to protect software programs from run-time attacks against memory pages while those pages are swapped to secondary memory. A hash value is computed for an agent page as it is swapped from primary memory to secondary memory. When the page is swapped back into primary memory from secondary memory, the hash value is recomputed to verify that the page was not modified while stored in secondary memory. Alternatively, the hash value is pre-computed and placed in an integrity manifest wherein it is retrieved and verified when the page is loaded back into primary memory from secondary memory.

Embodiments are directed to providing enhanced protection functionality to Virtualization Technology (VT) systems through a framework for measuring the integrity of software agents as well as enforcing protections for these agents using memory firewall functionality. Embodiments may be directed to both non-networked and networked versions of VT platforms, such as VT Integrity Services for Networking (VISN). In general, VISN platforms protect software agents running on a VT-based platform from modification by malware at runtime (for example against buffer overflow attacks). Embodiments are directed to providing a secure page swapping mechanism for privileged host agent code (Ring 0 agents), that overcomes present restrictions that these agents be pinned in memory. Embodiments also allow VT platforms to work with legacy operating system (OS) and regular user privilege agent code (Ring 3 agents). In general, during secure page swapping, a page is protected while it is transferred from primary to secondary memory and stored in primary memory, as well as when it is transferred back from secondary memory to primary memory.

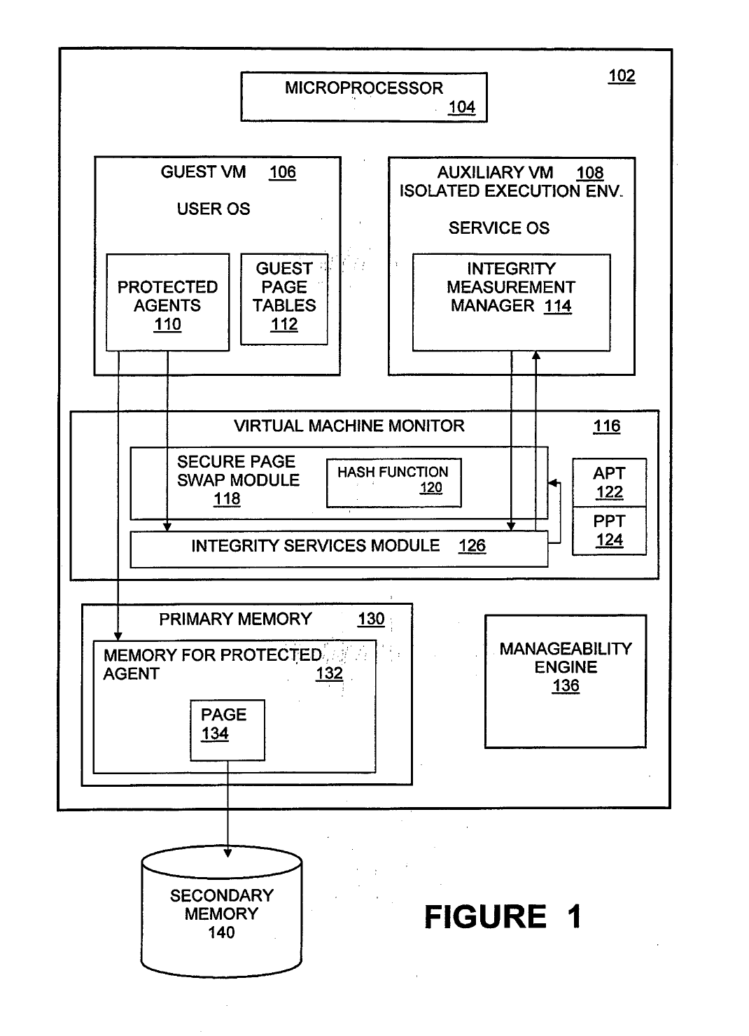

Aspects of the one or more embodiments described herein may be implemented on a computer, or computers executing software instructions. The computer may be a standalone computer or it may be networked in a client-server arrangement or similar distributed computer network. FIG. 1 is a block diagram of a computer system that implements embodiments of a secure page swapping mechanism for use in virtual memory systems. The computer 102 of FIG. 1 represents a portion of a computer that includes at least one microprocessor 104 and a primary memory 130. Computer 102 may be embodied on one or more motherboards, or integrated circuit devices comprising at least some other components of the computer, not shown. For example, computer 102 may include a memory controller, an interface controller, a bus coupling the components of the computer, as well as a number of buffers and similar circuitry for coupling the computer directly or indirectly to one or more on-board or off-board peripheral devices or networks. The microprocessor 104 may execute programming instructions of the computer 102, and may be single and/or multiple-core processor(s), controller(s), application specific integrated circuit(s), and so on.

The computer 102 of FIG. 1 includes one or more execution environments 106 and 108 that are the domain of respective executing operating systems. Thus, as shown in FIG. 1, execution environment 106 comprises a user operating system (OS) domain, and execution environment 108 comprises a service operating system domain. The service operating system domain 108 can represent an embedded microcontroller or similar isolated execution environment within computer 102, such as that provided by manageability engine 136. Another example would be a virtual machine. Either or both of user OS 106 and service OS 108 may be a component configured to execute and control general operation of other components within their respective execution environments.

As used herein, the term “component” refers to programming logic and associated data that may be employed to obtain a desired outcome. It may be synonymous with “module” or “agent” and may refer to programming logic that may be embodied in hardware or firmware, or in a collection of software instructions written in a programming language, such as C, C++, Java, Intel® Architecture 32 bit (IA-32) executable code, and so on.

In an embodiment, computer 102 includes a virtual memory manager that runs under an operating system and provides support for virtual memory operations that utilize paging to facilitate the emulation of a large logical/linear address space through the use of smaller physical memory pages 134. The execution environments 106 and 108 may provide one or more virtual execution environments in which the components may operate, which may then be mapped into physical pages of primary memory 130. Page tables maintained by the OS 106 and/or OS 108, map the logical/linear addresses provided by components of the execution environments to physical address of the memory 130. Pages 134 are swapped from the primary memory 130 to a secondary memory device 140 when they are not being actively used, in order to free up primary memory space to other processes. Upon a load request, e.g., from a loading agent of the OS 106 or OS 108, the virtual memory manager and/or the OS may load the stored page from secondary memory 140 into primary memory 130 as active content for operation of the component in the appropriate execution environment. As shown in FIG. 1, the pages for the protected agents may be stored within a memory space 132 for the protected agents within the primary memory 130.

In an embodiment, secondary memory 140 may represent non-volatile storage to store persistent content to be used for the execution of the components in computer 102 and may include integrated and/or peripheral storage devices, such as, but not limited to, disks and associated drives (e.g., magnetic, optical), universal serial bus (USB) storage devices and associated ports, flash memory, ROM, non-volatile semiconductor devices, etc. The secondary memory is typically some form of memory that is slower, larger, and possibly more persistent than primary memory. Secondary memory 140 may be a storage resource physically part of the computer 102 or it may be accessible by, but not necessarily a part of, the computer 102. For example, the secondary memory 140 may be accessed by the computer 102 over a network via a network interface controller. As shown in FIG. 1, the memory units 130 and 140 may organize content stored therein into a number of groups of memory locations. These organizational groups, which may be fixed and/or variable sized, are configured to facilitate virtual memory management, and may be in the form of pages, segments, or a combination thereof.

In general, the virtual memory manager represents a software module in the operating system that controls the transfer of pages back and forth between primary and secondary memory. In one embodiment, computer 102 of FIG. 1 includes a virtual machine monitor (VMM) 116 component, which represents a process that runs at an elevated privilege level in the computer, and presents multiple abstractions and/or views of the computer 102 hardware, e.g., one or more processor(s) 104, network interface controller, secondary memory storage 140, and/or primary memory 130, to the one or more independently operating execution environments or “virtual machines” 106 and 108. In one embodiment, the execution environment for the user operating system represents a “guest VM,” and the isolated execution environment for the service operating system represents an “auxiliary VM.” The auxiliary VM 108 may be configured to execute code independently and securely isolated from the guest VM 106 and may prevent components of the guest VM 106 from performing operations that would alter, modify, read, or otherwise affect the components of the auxiliary VM 108. While the FIG. 1 shows an embodiment with two virtual machines, it should be understood that other embodiments may employ any number of virtual machines.

In one embodiment, the user operating system of the guest VM 106 contains one or more protected agents 110. These agents represent program code or modules for active content that is swapped from primary memory 130 to secondary memory 140 upon a designated event through control of the virtual memory manager, and could represent Ring 0 agents or Ring 3 agents, or any type of privileged or user domain code. The protected agents 110 may register with an integrity services module (ISM) 126 within the VMM 116 for protection. The ISM 126 component may be a portion of a virtual machine monitor (VMM) process, or it may be part of another functional component within computer 102.

A memory protection component (MPC) within the ISM 126 provides memory firewall protections for the protected agents 110 based on parallel page tables facility provided by the VMM 116. The registration process may take place upon an occurrence of a registration event, e.g., loading of the active content from secondary to primary memory 130, periodically, and/or in some other event-driven manner. In various embodiments, the registration may be initiated by the protected agents 110, another component within the VM 106, e.g., the user OS, the VMM 116, or any other similar component, or it may be preconfigured by the system administrator. Upon receiving the registration, the ISM 126 may cooperate with an integrity measurement module (IMM) 114 operating in the auxiliary VM 108, or another isolated execution environment such as the manageability engine 136, to verify the integrity of the protected agents 110. In general, the IMM 114 measures the integrity of a protected agent at runtime by inspecting its code/data image in memory and comparing it against a pre-defined cryptographic hash for that agent or portion of the agent. Verification of the integrity of the protected agents 110 may help to prevent unauthorized modification and/or malicious termination, and may ensure that only recognized components may be afforded protection.

While FIG. 1 illustrates execution environments being virtual partitions, other embodiments may provide different execution environments through other mechanisms, e.g., using a service processor, and/or an embedded microcontroller. In various embodiments, an auxiliary environment may be partitioned from a host environment via a variety of different types of partitions, including a virtualized partition (e.g., a virtual machine in a VT scheme, as shown), and/or an entirely separate hardware partition, such as that utilizing active management technologies (AMT), a manageability engine (ME), a platform resource layer (PRL) using sequestered platform resources, a system management mode (SMM), and/or other comparable or similar technologies. In various embodiments, a VT platform may also be used to implement AMT, ME, and PRL technologies.

As shown in FIG. 1, the user OS-106 may create a guest page table (GPT) 112 in the OS domain that maps linear addresses of the protected agents executing in the guest VM to physical addresses, or page frames. The agents occupy specific page table entries (PTEs), which refer to page frames having active content. As is the case in VT platforms, the VMM 116 may monitor and trap register pointer (e.g., CR3 (Control Register 3)) changes. When the user OS 106 creates GPT 112 and provides a CR3 value pointing to the GPT 112, the VMM may trap on the CR3 change, create an active page table (APT) 122 (which may be a duplicate copy of the GPT 112) in the VMM domain, and change the control register value to the value pointing to the APT 122. In this way, the VMM can coordinate accesses to the primary memory 130 from a number of virtual machines, e.g., VM 106 and VM 108.

In this embodiment, the VMM 116 may also create a protected page table (PPT) 124. The VMM 116 may copy the page frames having the active content, into the PPT 124 and assign the page table entries in the GPT that refer to those page frames, with access characteristics to cause a page fault upon execution. In various embodiments, the access characteristics may be ‘not present,’ ‘execute disabled,’ and/or read-only. In an embodiment, the access characteristics may be ‘not present’ or a combination of ‘execute disable’ and read-only to prevent unauthorized modifications to the active content from the VM 108. For the embodiment shown in FIG. 1, computer system 102 includes a manageability engine (ME) 136, which provides trusted platform module (TPM) services, such as keys, passwords, digital certificates, and so on, for secure booting of the computer.

As shown in FIG. 1, the VMM 116 includes a secure page swap (SPS) module 118, which provides the secure page swapping functionality for pages 134 swapped between the primary memory 130 and secondary memory 140. The secure page swap module 118 includes a hash function component 120. The hash function 120 calculates a cryptographic hash value of an agent page as it is becoming ready to be swapped out to secondary memory by the user OS in guest VM 106. When the agent page is brought back into primary memory 130 from the secondary memory 120 by the user OS, the hash function 120 re-computes the hash value to make sure the page was not modified while in secondary memory. The hash function 120 chops and mixes the data within the page to create a digital fingerprint that represents the hash value. As long as the data within the page is unmodified, the hash value should not change. Although embodiments illustrate the use of a hash value, any similar encryption mechanism that provides a basis for comparison before and after a memory swap operation can be used, such as encryption/decryption of the page 134, and the like. The hash value, or similar encryption value, may also be referred to more generally as an integrity check value (ICV).

In one embodiment, the hash value can be pre-calculated and stored in an integrity manifest for the page. In one embodiment, the integrity manifest is a collection of information to be used in the verification of the integrity of the page or component, and can include one or more integrity check values and/or relocation fix-up locations, covering the stored content. In a typical scenario, the protected agent data pages are static and do not change in runtime. Alternatively, the data pages may be dynamic data pages, wherein a protected agent within a running application creates data structures for its own internal purposes. In this case, the integrity cannot be calculated and stored up front as is the case for static pages. For dynamic pages, the hash value is calculated for the page as it existed in the last instance prior to a swap operation.

As shown in FIG. 1, the hash values for the pages swapped between primary memory 130 and secondary memory 140 are computed in a hash function 120 within the VMM 116, and stored in a memory location within the VMM. Alternatively, the hash values can be calculated in a hash function that is executed on any hardware or software module within or coupled to computer 102. For example, the hash function may be embodied within a process in a memory controller or disk controller device coupled to the secondary memory 140, or any similar circuit.

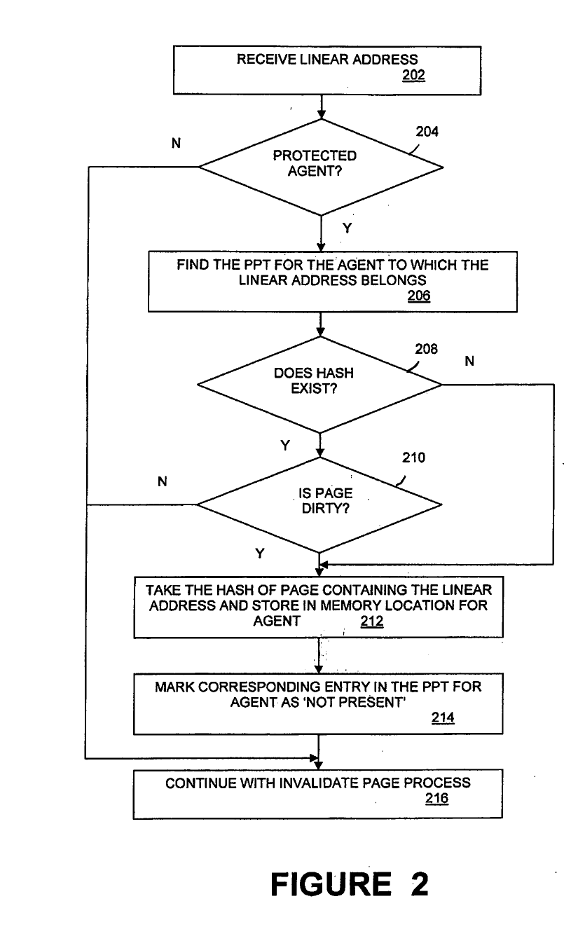

The hash function can be invoked in two general circumstances in which a page may be ready to get swapped to secondary memory. The first is when an invalidate TLB entry (INVLPG) instruction is used by the user OS to invalidate the TLB entry for a page. After this instruction the user OS could reclaim that page for another process and swap it out to the secondary memory. In case of a VT platform, the INVLPG instruction will cause a VM exit, and control will be transferred to the VMM 116. FIG. 2 is a flowchart that illustrates a method of performing a secure page swap in this circumstance. In general, the SPS module 118 in the VMM 116 will check if the page belongs to a protected agent and a hash has not been calculated before for the page. If this is true, the SPS will take a hash for that page and store it in its internal data structure, and then allow the page swapping procedure to proceed as normal.

Although the previous and following discussion may refer to specific registers, pointers, instructions (such as CR2, CR3, INVLPG) and so on, it should be noted that embodiments are not limited to specific registers or microprocessor architectures, and any similar structure, component, instruction, or equivalent thereof can be used.

In general, in a VT platform, a 32-bit linear address is presented to the paging unit of the SPS 118. A control register (e.g., CR3) points to the base address of a small page directory pointers table (PDPT), and each PDPT entry references a separate page directory, each of which points to a page table or directly to a page frame. As shown in FIG. 2, the INVLPG instruction provides the linear address and CR3 pointer value, block 202. In block 204, the process determines whether the CR3:LinearAddress (LA) belongs to a protected agent. If it does not, a hash value is not calculated, and the process continues with a standard invalidate page operation, block 216. If the linear address is for a protected agent, the protected page table entry for the agent is found, block 206. In block 208 the process determines whether a hash value already exists for the agent, in order to prevent unnecessary hash value calculations. If the hash value does exist, it is determined whether the page is dirty, block 210. If a hash value exists and the page is not dirty, the SPS module 118 will use this hash value, and the process continues with a standard invalidate page operation, block 216. If a hash value does not exist, or if it does exist and the page is dirty, a hash value for the page is calculated and stored in a memory location for the agent, block 212. The corresponding entry in the protected page table 124 for the agent is then marked as ‘not present,’ block 214. The process then continues with the invalidate page operation, block 216.

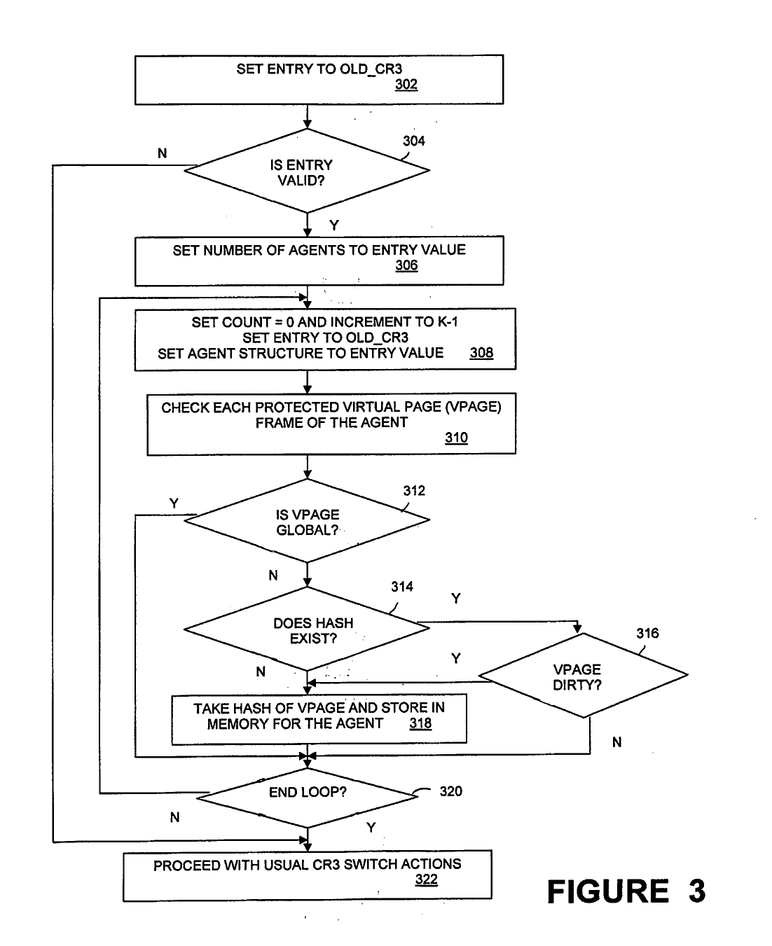

The second condition in which the agent pages could be swapped out to secondary memory 140 is when the user OS changes its control register context (CR3). In this case, the pages in the previous context may be reused and thus swapped out. In one embodiment of a VT platform, during a control register move instruction (e.g., “Move CR3”), which is used to change the OS context, control is transferred to the VMM 116. FIG. 3 is a flowchart that illustrates a method of performing a secure page swap in this circumstance. In general, the SPS module 118 will check if the pages in the old CR3 context belong to a protected agent and a hash has not been calculated before for the pages. If this is true, the SPS will take a hash for all the agent pages and store it in its internal data structure. The process of FIG. 3 illustrates switch CR3 operation which takes as input the old value of the register (Old_CR3). The process begins with the setting of the entry to Old_CR3, block 302. In block 304 it is determined whether the entry is valid. If not, the process proceeds with the normal CR3 switch actions, block 322. If the entry is valid, the number of the agent (NumAgents) is set to the entry value, block 306. A recursive loop from 0 to k−1 is then set up (for k number of protected agents), and the entry is set to the Old_CR3, and the agent structure (AgentStruct) is set to the entry value, block 308. The agent structure stores agent-specific information, such as agentID, PPT address, and so on.

In block 310, the process checks each protected virtual page (VPAGE) of the agent. In block 312 it is determined if the VPAGE is global. If it is global, the process proceeds to decision block 320 to process the next agent of the k agents. If it is not global, the process determines whether a hash value already exists, block 314. If a hash value does exist, the VPAGE is checked as to whether or not it is dirty, block 316. If a hash value exists and the page is not dirty, the SPS module 118 will use this hash value, and the process proceeds through the rest of the agents, and then performs the normal CR3 switch actions, block 322. If a hash value does not exist, or if it does exist and the VPAGE is dirty, a hash value for the VPAGE is calculated and stored in a memory location for the agent, block 318. The process then proceeds through the remaining agents, as determined in the end loop block 320, and ends with the normal CR3 switch actions, block 322.

In an alternative embodiment, the ICVs (hash values) for individual pages can be pre-specified in the integrity manifest for the program or application running under the user OS. This method has the advantage that for pages containing static content, no run-time ICV computation needs to be performed. Alternately, ICVs for individual pages can be computed at load-time, which would also reduce the run-time overhead of the process.

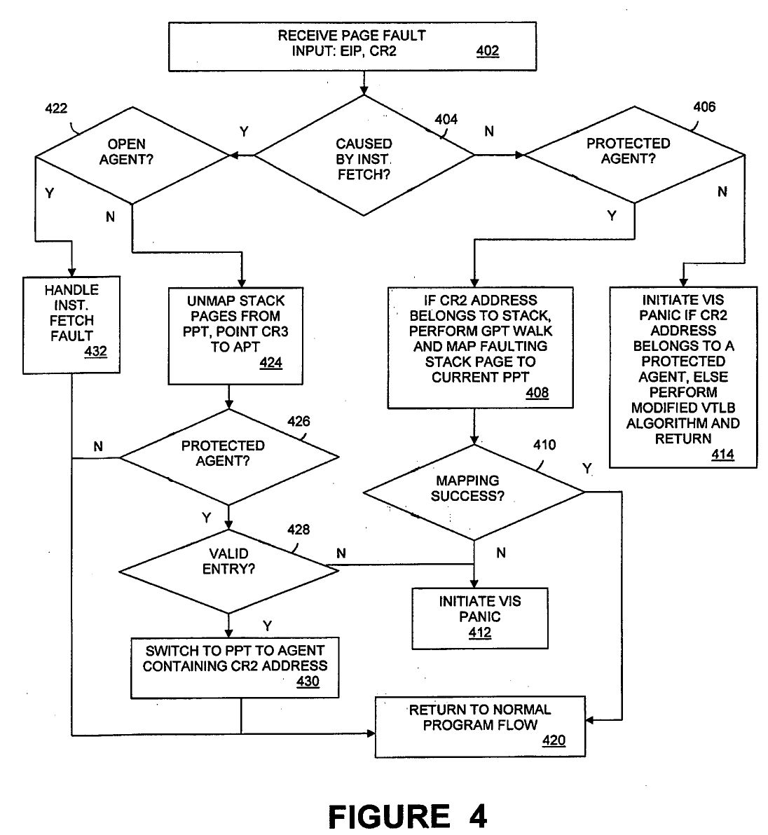

Once a page has been swapped out to secondary memory, it must be swapped back into primary memory if it is called by the user OS. The typical condition in which an agent page may be brought back into the primary memory from secondary memory is on a page fault. On a VT platform, during a page fault, control is transferred to the VMM 116. FIG. 4 is a flowchart that illustrates a method of performing a secure page swap for a page fault operation, under an embodiment. In general, the SPS module 118 checks to see if the page fault was caused by an instruction fetch or a data access. In both these cases, if the page belongs to the protected agent, it will re-compute the hash of the page and see if it matches the previous hash that was stored for that page. If the recomputed hash value does not match the previous hash value, it will cause a VMM integrity services (VIS) panic signal that essentially notifies the ISM 126 components that the page was tampered with while in secondary memory 140.

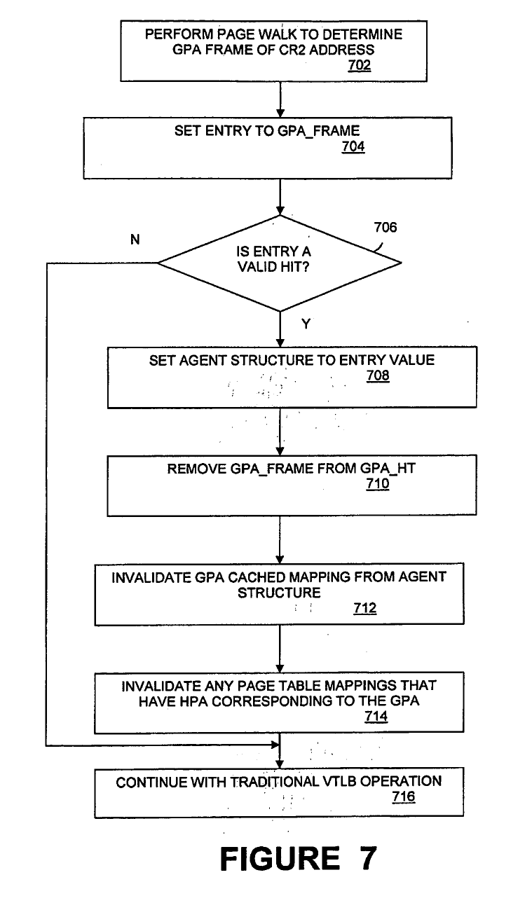

As shown in FIG. 4, the process begins with the page fault signal which provides as input the extended instruction pointer (EIP) value and a control register (CR2: control register 2) value. In block 404 it is determined whether the page fault was caused by an instruction fetch. If not, it was caused by a data access operation. In this case, the process determines whether the EIP value belongs to a protected agent, block 406. If it does belong to a protected agent, the process determines whether the CR2 address belongs to the stack, in which case the SPS performs a GPT walk and maps the faulting stack page to the current PPT, block 408. If the CR2 address does not belong to the stack, the process simply handles the data access fault and returns to main program flow. In block 410 the process determines whether the mapping of block 408 was successfully performed. If the mapping is not successful, the recomputed and previous hash values do not match, and a VIS panic signal is generated, block 412. If the mapping is successful, the hash values match, and the process returns to normal program flow, block 420. If, back in block 406, it is determined that the EIP does not belong to a protected agent, the process next determines whether the CR2 address belongs to a protected agent, block 414. If so, a VIS panic signal is initiated, otherwise a modified VTLB (virtual TLB) algorithm is performed and the process returns to normal program flow, as shown in block 414. Specific operations related to the modified VTLB algorithm are described in relation to FIG. 7 below.

As further shown in FIG. 4, if in block 404 it is determined that the page fault was caused by an instruction fetch, the process determines whether the EIP value belongs to an open agent, block 422. If it does, the process handles the instruction fetch fault, block 432 and returns to normal program flow, block 420. If the EIP does not belong to an open agent, the process unmaps the stack pages from the PPT, and points the CR3 pointer to the APT, block 424. In block 426, the process determines whether the CR2 address belongs to a protected agent. If not, the modified VTLB algorithm is performed and the process returns to normal program flow, block 420. Otherwise, the process checks whether or not the CR2 address represents a valid entry point, block 428. If it is a valid entry, the process switches to the PPT corresponding to the agent whose protected address range contains the CR2 address, block 430. However, if it is not a valid entry, as determined in block 428, a VIS panic signal is initiated, block 412.

In general process terms, the operating system creates a guest page table 112 that maps the linear addresses of the components executing in the guest VM 106 to physical addresses or page frames. When the operating system creates the GPT, the VMM 116 may create an active page table (APT) 122, which may be a duplicate copy of the GPT, in the VMM domain. In this way, the VMM can coordinate accesses to the memory from a number of virtual machines, e.g., VM 106 and VM 108. The VMM 116 may also create a protected page table (PPT) 124. The VMM may copy the page frames having active content into the PPT and assign page table entries that do not refer to those page frames with access characteristics (e.g., not present, read only, execute disabled, etc.) to cause a page fault upon execution.

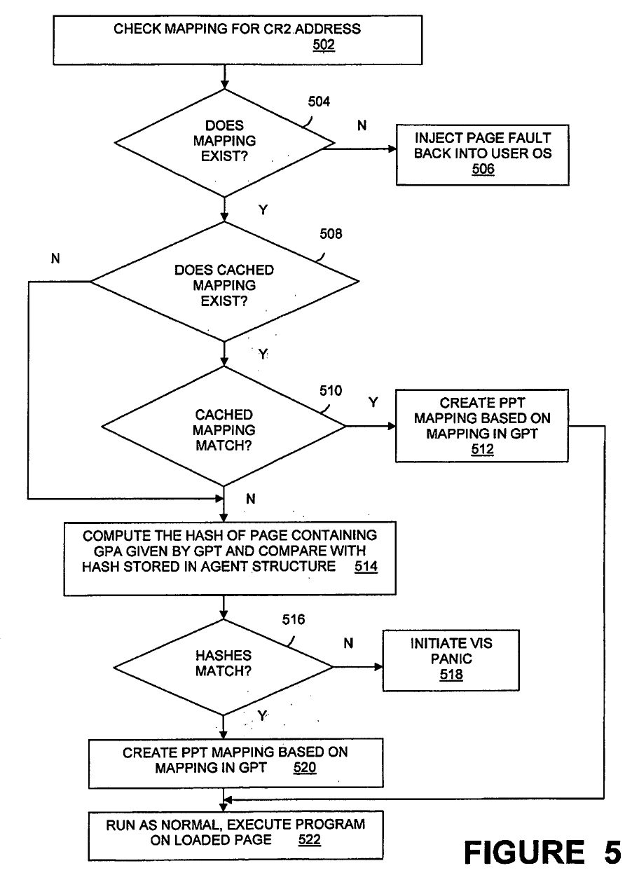

FIG. 5 is a flowchart that illustrates in more detail, particular instruction fetch and data access page fault operations for the process of FIG. 4, under an embodiment. For the process of FIG. 5, a data access fault operation takes as inputs the EIP, CR2, and agent structure values. In block 502, the process checks whether the mapping for the CR2 address exists in the GPT 112. If, in block 504 it is determined that such a mapping does not exist, the page fault is injected back into the user OS, block 506. If the mapping does exist, the process determines whether a cached mapping exists for the CR2 address in the agent structure, block 508. If it does not, the process computes the hash value of the page containing the guest physical address (GPA) given by the GPT and compares this hash value with the hash value stored in the agent structure, block 514, and continues on with the remaining operations of FIG. 5. The agent structure is essentially the context information stored in VMM 116, or similar storage, that describes the current state of a protected agent.

If, in block 508 it is determined that the mapping does exist, the process first determines whether the cached mapping matches the mapping given by the GPT, block 510. If there is a match, the process creates a PPT mapping based on the mapping in the GPT, block 512, and then returns to normal program flow where the program executes on the loaded page, block 522. If, in block 510, it is determined that the cached mapping does not match the GPT mapping, the process computes the hash of the page, as shown in block 514. From block 514, the process proceeds to block 516 in which it is determined whether the hash of the page given in the GPT matches the hash stored in the agent structure. If the hashes do not match, a VIS panic signal is generated, block 518. If the hashes do match, a PPT mapping based on the mapping in the GPT is created, block 520. This is done by caching the linear address to the GPA mapping given by the GPT into the agent structure. The process then returns to normal program flow on the loaded page, block 522.

The instance in which a page fault occurs is when the protected agent is trying to run, i.e., the user OS is switching to the protected agent. In this case, the SPS 118 will go through the entries for the protected agent in the guest page table and try to determine if any of them differ from what it had cached. If the entries have changed, the process will re-compute the hash for those pages and check the recomputed hash value with the value it had previously stored.

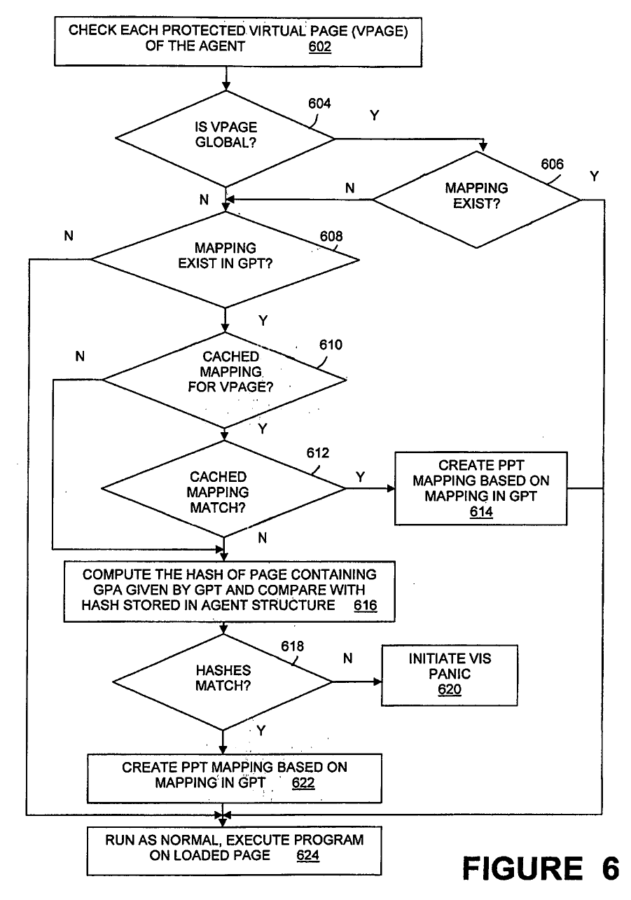

FIG. 6 is a flow diagram that illustrates a method of computing and checking hash values when the protected agent is trying to run, under an embodiment. For the process of FIG. 6, a handle agent switch operation takes as inputs the EIP, CR2, and agent structure values. In block 602, the process checks each protected virtual page (VPAGE) of the agent to determine whether the VPAGE is a global page. If, in block 604 it is determined that the agent is a global page, the process determines whether a mapping exists in the PPT for the VPAGE, block 606. If it does, the process returns to normal program flow, block 624. If the mapping does not exist, or if the VPAGE is not global, the process determines whether the mapping for the VPAGE exists in the GPT, block 608. If it does not, the process proceeds to check the next VPAGE frame. Otherwise, the process determines whether a cached linear address to guest page address mapping exists for the VPAGE in the agent structure, block 610. If it does not, the process computes the hash of the page containing the GPA given by the GPT and compares this hash value with the hash value stored in the agent structure, block 616, and continues on with the remaining operations of FIG. 6.

If, in block 610 it is determined that the cached mapping for the VPAGE does exist, the process then determines whether the cached mapping matches the mapping given by the PPT, block 612. If it does, the process creates a PPT mapping based on the mapping in the GPT, block 614, and then processes any additional protected VPAGE frames for the agent before returning to normal program flow, block 624. If, in block 612, it is determined that the cached mapping does not match the GPT mapping, the process computes the hash of the page, as shown in block 616. From block 616, the process proceeds to block 618 in which it is determined whether the hash of the page given in the GPT matches the hash stored in the agent structure. If the hashes do not match, a VIS panic signal is generated, block 620. If the hashes do match, a PPT mapping based on the mapping in the GPT is created, block 622. This is done by caching the linear address to the GPA mapping given by the GPT into the agent structure. The process then returns to normal program flow on the loaded page, block 624.

As shown in FIG. 4, a modified VTLB process may be performed in certain circumstances, such as if the EIP belongs to a protected agent, but the CR2 address does not belong to a protected agent for a fault that is not caused by an instruction fetch. FIG. 7 is a flow diagram that illustrates a method for a modified virtual TLB operation in a secure page swap system, under an embodiment. The process blocks generally describe the modifications to the VTLB process on a page fault for the SPS functionality. In one embodiment, the modified VTLB process takes as input the CR2 value. In block 702, the process performs a page walk to determine the GPA frame of the CR2 address. In block 704, the entry is set to the GPA Frame value and then the process determines whether the entry is valid (hit), block 706. If the entry is not valid, the process continues with a traditional VTLB operation, block 716. If, in block 706 it is determined that the entry is valid, the process sets the agent structure to the entry value, block 708. The GPA frame is then removed from the GPA hash table (HT), block 710. In block 712, the process invalidates the virtual address to GPA cached mapping from the agent structure for the agent. Any PPT mappings that have an HPA value corresponding to this GPA are invalidated, block 714. The process then continues with traditional VTLB operation, block 716.

Through the described structures and methods, embodiments are directed to facilitate the secure paging for protected host agent code in a VT enabled platform. The secure page swapping mechanism allows legacy host agents in Ring 0 and Ring 3 to leverage traditional VT integrity services without much or any modification.

Although the present embodiments have been described in connection with a preferred form of practicing them and modifications thereto, those of ordinary skill in the art will understand that many other modifications can be made within the scope of the claims that follow. Accordingly, it is not intended that the scope of the described embodiments in any way be limited by the above description, but instead be determined entirely by reference to the claims that follow.

For example, embodiments can be implemented for use on a variety of different multiprocessing systems using different types of CPUs. Furthermore, although embodiments have been described in relations to compilers and code generators for translating high level language programs to target binary code, it should be understood that aspects can apply to any type of language translator that generates target code for execution on any type of computer system or computing device.

For the purposes of the present description, the term “processor” or “CPU” refers to any machine that is capable of executing a sequence of instructions and should be taken to include, but not be limited to, general purpose microprocessors, special purpose microprocessors, application specific integrated circuits (ASICs), multi-media controllers, digital signal processors, and micro-controllers, etc.

The memory associated with the system illustrated in FIG. 1, may be embodied in a variety of different types of memory devices adapted to store digital information, such as static random access memory (SRAM), dynamic random access memory (DRAM), synchronous dynamic random access memory (SDRAM), and/or double data rate (DDR) SDRAM or DRAM, and also non-volatile memory such as read-only memory (ROM). Moreover, the memory devices may further include other storage devices such as hard disk drives, floppy disk drives, optical disk drives, etc., and appropriate interfaces. The system may include suitable interfaces to interface with I/O devices such as disk drives, monitors, keypads, a modem, a printer, or any other type of suitable I/O devices.

Aspects of the methods and systems described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Implementations may also include microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

While the term “component” is generally used herein, it is understood that “component” includes circuitry, components, modules, and/or any combination of circuitry, components, and/or modules as the terms are known in the art.

The various components and/or functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

The above description of illustrated embodiments is not intended to be exhaustive or limited by the disclosure. While specific embodiments of, and examples for, the systems and methods are described herein for illustrative purposes, various equivalent modifications are possible, as those skilled in the relevant art will recognize. The teachings provided herein may be applied to other systems and methods, and not only for the systems and methods described above. The elements and acts of the various embodiments described above may be combined to provide further embodiments. These and other changes may be made to methods and systems in light of the above detailed description.

In general, in the following claims, the terms used should not be construed to be limited to the specific embodiments disclosed in the specification and the claims, but should be construed to include all systems and methods that operate under the claims. Accordingly, the method and systems are not limited by the disclosure, but instead the scope is to be determined entirely by the claims. While certain aspects are presented below in certain claim forms, the inventors contemplate the various aspects in any number of claim forms. Accordingly, the inventors reserve the right to add additional claims after filing the application to pursue such additional claim forms for other aspects as well.

What is claimed is:

1. A method comprising:
creating an initial hash value for a page stored in a primary memory of a computer;
swapping the page from primary memory to secondary memory; and
recomputing the hash for the page when it is swapped back to the primary memory from the secondary memory.

2. The method of claim 1, wherein the computer includes a virtual memory system, the method further comprising:
verifying whether the recomputed hash value matches the initial hash value; and
generating an integrity panic signal in the event that the recomputed hash value does not match the initial hash value.

3. The method of claim 2, wherein the integrity panic signal causes an action selected from the group consisting of transmitting an alert message to a system administrator, removing the computer from a network, and patching incorrect program code for the page.

4. The method of claim 1, wherein the page comprises data selected from a group consisting of non-privileged content data, and privileged content data created by a supervisory function of an operating system executed on the computer.

5. The method of claim 1, wherein the primary memory comprises random access memory in the computer, and the secondary memory comprises a hard disk.

6. The method of claim 5 wherein the page comprises content data for a protected agent, the method further comprising storing the page in a dedicated agent data store within the primary memory space.

7. The method of claim 6 further comprising measuring the integrity of the protected agent at runtime by inspecting a data image in primary memory and comparing it against a pre-defined manifest for the protected agent.

8. The method of claim 1, wherein the page is swapped back to the primary memory from the secondary memory in response to a page fault.

9. A system comprising:
a guest execution environment to host a user operating system for execution on a microprocessor, and including at least one protected agent comprising privileged execution code;
a primary memory space to store one or more pages embodying content of the at least one protected agent;
a secondary memory coupled to the primary memory to temporarily store the one or more pages when the protected agent is not actively used by the user operating system;
a virtual machine monitor to facilitate swapping of the one or more pages from primary memory to secondary memory upon initiation of a virtual memory operation; and
a secure page swap module to compute an initial hash value of a page of the one or more pages prior to swapping from primary memory to secondary memory, and recompute the hash value upon swapping back of the page from secondary memory to primary memory.

10. The system of claim 9, further comprising an integrity services module to initiate an integrity panic signal if the recomputed hash value does not match the initial hash value.

11. The system of claim 10 further comprising an isolated execution environment to host a service operating system executed on a microprocessor, and including an integrity measurement manager configured to measure the integrity of the protected agent at runtime by inspecting a data image in primary memory and compare it against a pre-defined manifest for the protected agent.

12. The system of claim 10, wherein the page comprises data selected from a group consisting of non-privileged content data, and privileged content data created by a supervisory function of an operating system executed on the computer.

13. The system of claim 11, wherein the primary memory comprises random access memory coupled to the microprocessor, and the secondary memory comprises a hard disk.

14. The system of claim 13 wherein the page comprises content data for a protected agent, the method further comprising storing the page in a dedicated data store within the primary memory space.

15. The system of claim 11 further comprising a memory control circuit coupled to the secondary memory, the memory control circuit including a hash component to compute the initial hash and recompute the hash value upon swapping back of the page from the secondary memory.

16. A machine-readable medium having a plurality of instructions stored thereon that, when executed by a processor in a system, performs the operations of:
creating an initial hash value for a page stored in a primary memory of a computer;
swapping the page from primary memory to secondary memory; and
recomputing the hash for the page when it is swapped back to the primary memory from the secondary memory.

17. The machine-readable medium of claim 16, further comprising instructions that initiate an integrity panic signal if the recomputed hash value does not match the initial hash value.

18. The machine-readable medium of claim 17, further comprising instructions that measure the integrity of the protected agent at runtime by inspecting a data image in primary memory and comparing it against a pre-defined manifest for the protected agent.
